(19) United States
(12) Patent Application Publication
(10) Pub. No.: US 2020/0193524 A1
(43) Pub. Date: Jun. 18, 2020

(54) Determining Risk Relating to Real Estate and Reconstruction

(71) Applicant: KBC GROEP NV, Brussels (BE)

(72) Inventors: Hans Verstraete, Schoten (BE); Barak Chizi, Woluwe (BE); Tomas Matyska, Hlubocepy (CZ); Tayena Hendrickx, Wespelaar (BE); Natasja Maes, Haasrode (BE); Rita Van Gasse, Sint-Niklaas (BE)

(21) Appl. No.: 16/614,363

(22) PCT Filed: May 14, 2018
(86) PCT No.: PCT/EP2018/062401

§ 371 Date: Nov. 17, 2019

Related U.S. Application Data
(60) Provisional application No. 62/508,094, filed on May 18, 2017.

(30) Foreign Application Priority Data
May 18, 2017 (EP) 17171800.0

(51) Int. Cl. G06Q 40/08; G06Q 30/02; G06Q 50/16; H04W 4/029; H04W 4/021

(52) U.S. Cl. CPC G06Q 40/08; G06Q 30/0206; H04W 4/021; H04W 4/029; G06Q 50/165

(57) ABSTRACT

The current invention relates to a computer-implemented method for determining a risk associated with a physical entity based on physical data, said physical entity relating to real estate, said risk relating to a probability of damage of said physical entity with respect to a physical parameter comprised in said physical data, said method comprising the steps of: receiving, from a user, a geographical address of said physical entity; receiving, from the user, an entity category relating to said physical entity, said entity category being one of a row house, a semi-detached house, a detached house or an apartment; automatically determining said risk based on at least on said entity category; automatically determining a set of geographical coordinates of said physical entity based on said geographical address; automatically retrieving at least one value of said physical parameter belonging to said physical data based on said geographical coordinates from a database.

### TECHNICAL FIELD

The invention pertains to the technical field of determining a risk associated with a physical entity based on physical data, said physical entity relating to real estate.

### BACKGROUND

Building owners often prefer to minimize their risks of loss due to flooding, fire and other hazards by obtaining insurance to indemnify them against the cost of reconstructing the insured property. From the perspective of the insurer, the ability to accurately estimate building reconstruction costs is essential for setting an appropriate premium for such a policy. For both the insurer and the building owner, it is furthermore vital to determine the risk associated with the building.

Unfortunately, existing methods for estimating reconstruction costs are complex, inefficient and often inaccurate. Moreover, existing methods for assessing the risk associated with physical entities such as buildings are overly complex for the user or do not take into account the physical data available to assess said risk.

There remains a need in the art for an improved system and related method to estimate the reconstruction cost of a building or apartment and to automate the generation of a prospect. Related, there remains a need in the art for an improved method and related system to determine the risk associated with a physical entity based on physical data, said physical entity relating to real estate.

US 2003/0115163 describes systems and methods for estimating a reconstruction cost for a building as well as for a designated area within a building. Reconstruction pricing data based on builder-supplied full reconstruction-cost data are stored in a database from which the data is accessed by geographic location, building-category and building-area type. The accessed data are used to produce the reconstruction cost estimate. The price data for the geographic location of an existing building, is obtained from a database based on the geographic location data input by a user. The pricing level data for reconstructing the building and different building areas within a building, are also obtained from the database. The reconstruction cost estimate is calculated by a processor, based on price data of location and reconstruction price data. As such, US 2003/0115163 is primarily directed at improving the accuracy of estimations. Correspondingly, a problem with US 2003/0115163 is that the number of parameters needed to be able to generate a reconstruction-cost estimate is excessively high, leading to a complex and tedious use of the system. This is related with the estimation approach followed in US 2003/0115163, based on traditional criteria such as the size of the living area. Furthermore, the concept of US 2003/0115163 lacks means to take into account the number of floors of the building and, in case of an apartment building, the existence of separate apartments within the apartment building. Related, the approach of US 2003/0115163 is overly complex and furthermore incomplete when it comes to taking into account physical data in determining the risk associated with a physical entity relating to real estate.

US 2013/0211790 discloses a system and method for construction estimation using aerial images. The system receives at least one aerial image of a building. An estimation engine processes the aerial image at a plurality of angles to automatically identify a plurality (e.g., perimeter and interior) lines in the image corresponding to a plurality of features of a roof the building. The estimation engine allows users to generate two-dimensional and three-dimensional models of the roof by automatically delineating various roof features, and generates a report including information about the roof of the building. The system has computer systems for receiving an aerial image of a building. An estimation engine is provided in the computer system for processing the aerial image to estimate multiple features relating to a roof of the building. An estimation engine histogram is provided for processing the aerial image at multiple angles to automatically identify multiple lines in the aerial image corresponding to multiple features of the roof. A graphical user interface is provided for displaying the aerial image of the building. A problem with US 2013/0211790 is that it offers only partial means for estimating the reconstruction cost of a building. For instance, it lacks means for identifying apartments within a building, as well as means for taking into account aspects that are critical to the reconstruction cost, such as features of the neighborhood in which the building is located. Also, the approach of US 2013/0211790 is complex and inadequate for the aim of taking into account physical data in determining the risk associated with a physical entity relating to real estate.

The present invention aims to resolve at least some of the problems mentioned above. The invention thereto aims to provide an adequate means of and related system for determining a risk and/or for estimating reconstruction cost.

### SUMMARY OF THE INVENTION

In a first aspect, the present invention provides a computer-implemented method according to claim 1.

This method advantageously comprises said automated retrieval of said value of said physical parameter, which may be crucial for assessing risk. Said retrieval is done automatically and based on common knowledge of data such as the geographical address, which may be assumed known to any user as primary feature of said physical entity, which hence contributes to a positive user experience. Moreover, the method advantageously utilizes said value of said physical parameter via selective triggering, wherein the effort required by the method from the user is reduced. Since the value of the physical parameter may be critical in the assessment of the risk, it may be considered more user-friendly to include said additional step only if said predefined value is equaled or exceeded. In a preferred embodiment, equaling or exceeding said predefined value relates to an augmented risk and/or to an increased probability that said risk is high, whereas the opposite may hold true when said predefined value is not equaled nor exceeded, with reduced/low risk and/or reduced probability that said risk is high. Hence, it is advantageous to keep the complexity of the method as low as possible when the risk is reduced/low, while including the additional step when said predefined value is equaled or exceeded. This additional step may relate to receiving an additional physical value from said user, which may enable to provide a more accurate calculation of risk in this case and/or may provide an operator examining the risk with more detailed information regarding reasons and/or circumstances of the predefined value being equaled or exceeded. Additionally or alternatively, the additional step may relate to providing additional information to said user. For instance, the user may be provided with information relating to the fact that, based on the geographical address, the physical entity is associated with said value of said physical parameter equaling or exceeding said predefined value.

Hereby, said automatically determining of said risk, said automatically determining of said set of geographical coordinates and said automatically retrieving may be automatic in that they relate to inter-machine operations or machine-to-machine interaction. In a preferred embodiment, said method is carried out by a risk-determining server which may or may not be the server mentioned in this document. In such an embodiment, the risk-determining server may be configured for said determining of said risk preferably autonomously, based on at least said entity category received from the user and the at least one value of said physical parameter. Hereby, said geographical coordinates are preferably calculated locally at said risk-determining server but may alternatively be determined through a positioning-service-related interaction with a positioning-related remote server, such as a remote geographic information system server. Furthermore, the retrieving of said at least one value of said physical parameter may be performed locally by means of said database stored at said risk-determining server but may also be performed via a physical-parameter-service-related interaction with physical-parameter-related remote server, such as a physical-parameter-determining remote server configured for receiving said set of geographical coordinates as input value and returning said value of said physical parameter as output value.

In a second aspect, the invention offers a system according to claim 12. In a third aspect, the invention offers a use of the method according to claims 1-11 in the system according to claims 12-14. The advantages of the system and the use are similar to those of the method.

Further preferred embodiments are discussed in the detailed description and the dependent claims.

### DESCRIPTION OF FIGURES

FIG. 1 illustrated an example workflow relating to the present invention.

### DETAILED DESCRIPTION OF THE INVENTION

In this document, the term “physical entity” refers to any physical structure or domain that is identifiable as a permanent or semi-permanent space where people may reside and/or spend time. Hence, the term “physical entity” is used largely interchangeably with “building” unless where indicated. This encompasses the full range from privately-owned buildings like houses or apartment buildings to library buildings, town halls, hotel or restaurant buildings, sport stadiums, etc. This may concern a building built with conventional material such as brick, concrete, steel or wood, but it may as well be a cave excavated in rock or soil. It may concern a permanent structure but it may have a semi-permanent character, as in the case of a trailer, a container, a caravan or a tent. Furthermore, the term “apartment” refers to any space where people may reside and/or spend time, whereby the apartment belongs to said building. In the context of the present invention, the difference between an apartment and a building is purely formal and merely defines the mutual relation between the apartment and the building, whereby the latter comprises the former. Generally speaking, a building may comprise an apartment but may, in itself, be comprised in a second, larger building.

In this document, the term “geographical address” or “address” refers to the physical address of a building or an apartment belonging to that building. The address concerns a collection of information indicative of the location of the building or the apartment. Typically, the collection includes a nation/city/county and/or other political boundary, a street name, along with other identifiers such as house or apartment numbers. The address may also contain one or more special codes. One such code is a postal code, to make identification easier. Another special code is the longitude and latitude of the building or the apartment. This may relate to said set of coordinates and may be useful as a secondary or alternative means of localization of the building or apartment, and may furthermore be crucial in the case no address is definable or available.

In this document, embodiments are discussed which may relate to all aspects of the invention, i.e. at least to any of the method, the system and the use according to the present invention.

In a first aspect, the invention relates to the method according to claim 1.

In a preferred embodiment, said value of said physical parameter is based at least in part on automatic measurement of said physical parameter, preferably on automatic real-time measurement of said physical parameter. For instance, a network of sensors may be present for measuring flooding in the area in which the physical entity is located. In another example, seismic activity is measured by means of sensors present in the soil or in buildings located in the vicinity of the physical entity. The measurements of such sensors may be collected offline and recorded in the database, but may preferably be written to the database in real-time. Such an embodiment is advantageous because it automates the process of screening said physical parameter.

This may lead to a more accurate view on the actual risk.

In a preferred embodiment, said method comprises the further step of providing an output based on said risk to said user, said output preferably comprising said risk and/or a risk category. This is advantageous since it informs the user directly of the risk. This may be contrasted with a method wherein said risk is calculated and used in the calculation of some further measure, without informing the user of the risk as calculated.

In another preferred embodiment, said additional step selectively triggered by said equaling or exceeding said predefined value relates at least to said receiving of said additional physical value; wherein said additional step comprises:
receiving, from the user, said additional physical value being a risk-indicative feature value relating to said physical entity;

and wherein said determining of said risk is further based on said risk-indicative feature value. This is advantageous since it may lead to more accurate calculation of the risk, associated with a limited set of one or more specific questions of high relevance, while avoiding that the user needs to answer an abundance of generic questions of potentially low relevance.

In a preferred embodiment, said method comprises the further step of:
providing, to the user, a first and second risk value, wherein said first risk value is determined without taking into account said risk-indicative feature value, and wherein said second risk value is determined taking into account said risk-indicative feature value, for quantifying an impact of said risk-indicative feature value on said risk and allowing said user to assess said impact.

Such an embodiment may be advantageous because it allows the user to assess the impact of certain features of said physical entity.

In another preferred embodiment, said additional step selectively triggered by said equaling or exceeding said predefined value relates at least to said providing of said additional information to said user, wherein said additional step comprises:
providing, to the user, additional information comprising an advice with respect to said physical entity, said advice comprising a technical measure;

and wherein said technical measure relates to a modification of said physical entity which may be carried out by/via said user for lowering said risk. Such an embodiment may advantageously provide the user with specific, highly relevant information as to how he/she may take action so as to lower the risk. An example is given in the Examples section.

In another embodiment, said advice further comprises a first and second risk value, wherein said first risk value is determined assuming said technical measure is not implemented, and wherein said second risk value is determined assuming said technical measure is implemented, for quantifying an impact of said risk-indicative feature value on said risk and allowing said user to assess said impact. This further increases the relevance of the advice and the technical measure comprised therein, leading to better insight of the user.

According to yet another embodiment, said method further comprises the step of:
receiving, from the user, a characteristic value relating to said physical entity, said characteristic value relating to at least one of a physical surface or a number of floors characteristic of said physical entity;

and wherein said determining of said risk is further based on said characteristic value. Such an embodiment may be advantageous since the risk of damage should be assessed in view of the overall size of the physical entity.

In another preferred embodiment, said method comprises the further step of:
providing, to the user, a construction or reconstruction requirement relating to said physical entity based on said risk, said entity category and preferably on said characteristic value.

In one embodiment, the physical entity relates to newly-built real estate or real estate that is yet to be built, and a construction requirement is provided. In another embodiment, the physical entity relates to existing real estate, and a reconstruction requirement in case of damage or loss of the physical entity is provided which relates to a reconstruction of said physical entity. The reconstruction requirement may consist of one or more technical requirements to be fulfilled with respect to the physical entity or its reconstruction. For instance, a reconstruction requirement entity category may be provided, which in a preferred embodiment is equal to the entity category. The one or more technical requirements may further relate to a reconstruction instruction with respect to said physical entity, preferably an instruction with respect to a foundation and/or a fire protection provision and/or a dam and/or a detection system of seismic activity. Such an embodiment is advantageous in that it facilitates the technical activity of listing requirements involved in the construction or reconstruction of said physical entity.

In another preferred embodiment, said method comprises the further steps of:
retrieving comparative entity-category data from a second database, said second database preferably being said database, based on said entity category and preferably further based on said characteristic value;
retrieving geo-indexed data from a third database, said third database preferably being said database and/or said second database, based on said address and/or said entity category and/or said characteristic value; preferably based on said address and said entity category and said characteristic value;
providing, to the user, a construction or reconstruction cost and/or a construction or reconstruction difficulty relating to said physical entity based at least on said risk, said comparative entity-category data, said geo-indexed data and preferably further based on said characteristic value and/or said reconstruction requirement.

Hereby, comparative entity-category data refers to relative levels of risk and/or difficulty and/or pricing for constructing or reconstructing each of a plurality of different entity categories. Furthermore, comparative building-category data preferably may be an example of said comparative entity-category data. Geo-indexed data refers to data indexed by the geographic location indicating the difficulty of building and/or indications thereof, such as the cost of construction or reconstruction, based on pricing data for a plurality of different entity categories at the given location. Price-index data may be an example of said geo-indexed data. In one embodiment, the physical entity relates to newly-built real estate or real estate that is yet to be built, and a construction cost is provided. In another embodiment, the physical entity relates to existing real estate, and a reconstruction cost in case of damage or loss of the physical entity is provided which relates to a reconstruction of said physical entity.

In another preferred embodiment, said risk relating to said probability of damage relates to a probability of damage caused by flooding of said physical entity; in that said physical parameter and said at least one value of said physical parameter relate to a probability of flooding associated with a given physical location.
In one further embodiment, said additional step selectively triggered by said equaling or exceeding said predefined value relates at least to said receiving of said additional physical value; wherein said additional step comprises:
receiving, from the user, said additional physical value being a risk-indicative feature value relating to said physical entity; wherein said determining of said risk is further based on said risk-indicative feature value; wherein said risk-indicative feature value relates to any of the following: a presence and/or physical surface of a subterranean space, preferably a basement, of said physical entity; a floor level of said physical entity in case said entity category is apartment.
In another further embodiment, said additional step selectively triggered by said equaling or exceeding said predefined value relates at least to said providing of said additional information to said user, wherein said additional step comprises: providing, to the user, additional information comprising an advice with respect to said physical entity, said advice comprising a technical measure; wherein said technical measure relates to a modification of said physical entity which may be carried out by/via said user for lowering said risk, wherein said technical measure preferably relates to a subterranean space, preferably a basement, of said physical entity and/or a lowest floor level of said physical entity.

Such an embodiment and each of said further embodiments may be advantageous since it adequately addresses the problem of determining risk in view of flooding. The advantages are discussed in more detail in the Examples section.

In a second aspect, the invention provides a system according to claim 12.

In a preferred embodiment, said determining of said set of geographical coordinates based on said geographical address is performed by a positioning-related remote server different from said server. In a related preferred embodiment, said computer-readable medium comprising said database is comprised in a physical-parameter-related remote server different from said server. This is advantageous in that it offers modularity, allowing for a system that is easier to manage and/or more predictable in its operation and/or more adequate for delegating certain method steps to third parties. In a further preferred embodiment, said positioning-related remote server is equal to said physical-parameter-related remote server.

In a preferred embodiment, one or more steps of the method may be performed via a dedicated graphical interface on a user device, but may also be done via a plug-in or back-end functionality of some larger application or web service with website, which may be an in-house application or web service or a third-party application or web service. In certain embodiments, such an application may relate e.g. only to apartments. In such a case, the use of the application may entail that the user refers to a physical entity that is an apartment, and hence, the second step need not be run explicitly, but is implied by the context and the fact that the user is using the application.

In a preferred embodiment, the user is requested for the geographical address and the entity category for a plurality of purposes, of which the determining of risk is only one purpose. For instance, an application or web service that provides the context for the present invention may relate to the estimation of the reconstruction cost of said physical entity, for instance with a system and prospect according to points 1 to 15. For such estimation, it may be crucial to determine said risk. For instance, it may be useful to determine whether the physical entity is located e.g. in a flooding area, to determine the type of foundations required. In another example, the physical entity being located in a zone with increased fire hazard may indicate that appropriate building materials, e.g. fireproof building materials, are required.

According to a further aspect, which is not intended to limit the invention in any way, the invention pertains to the technical field of estimating the reconstruction cost of a building or apartment and generating a prospect relating to said building or apartment, and may or may not relate to following points 1-15.
1. A computing system for estimation of a reconstruction cost, the computing system comprising
   a server, the server comprising a processor, tangible non-volatile memory, program code present on said memory for instructing said processor;
   at least one computer-readable medium, the at least one computer-readable medium comprising a database, said database comprising reconstruction-pricing data comprising:
      a plurality of price-index data indexed by a corresponding geographic location and representing reconstruction-pricing data for a plurality of different building types and a plurality of different building-area types within a building,
      comparative building-category data representing relative pricing levels for reconstructing each of a plurality of different building categories, and
      optionally, comparative apartment data representing relative pricing levels for reconstructing each of a plurality of different apartment types within a building;
said computing system configured for carrying out a method for said estimation of said reconstruction cost for a building and/or an apartment belonging to said building, said method comprising the steps of:
   (a) receiving a set of key user input parameters belonging to a user input from a user at said server; said key user input relating to said building and/or said apartment belonging to said building from a user;
   (b) retrieving building-related data relating to said user input from said database;
   (c) determining building category-defining data for said building based on said building-related data;
   (d) optionally, determining apartment-type data for said apartment belonging to said building, the apartment-type data being selected from the plurality of different apartment types;
   (e) retrieving price-index data relating to said user input from said database;
   (f) retrieving relevant comparative building-category data from the database for said building based on the building category-defining data determined in step (c);
   (g) optionally, retrieving relevant comparative apartment data from the database based on the apartment type data determined in step (d);
   (h) determining whether sufficient information is available for generating a reconstruction-cost estimate for the building and/or the apartment belonging to said building:
      (h.1) if yes, proceeding to step (i);
      (h.2) if no, receiving further user input parameters belonging to said user input from said user and returning to step (b);
   (i) generating said reconstruction-cost estimate for the building and/or the apartment belonging to said building based at least on the price-index data retrieved in step (e), the relevant comparative building-category data retrieved in step (f) and optionally the relevant comparative apartment data in step (g);
characterized in that, said set of key user input parameters consists only of (A) an address of said building and/or an apartment belonging to said building, (B) in case of an apartment, an area of said apartment, and optionally of (C) said building type of said building and/or optionally of (D) a number of levels of said building, and in that said building type of said building is one of a row house, a semi-detached house, a detached house or an apartment building.
2. A computing system according to point 1, characterized in that, said set of key user input parameters consists only of (A) an address of said building and/or the apartment belonging to said building, (B) in case of an apartment, an area of said apartment, and of (C) said building type of said building.
3. A computing system according to point 1, characterized in that, said set of key user input parameters consists only of (A) an address of said building and/or the apartment belonging to said building, (B) in case of an apartment, an area of said apartment, and of (D) a number of levels of said building.
4. A computing system according to point 1, characterized in that, said set of key user input parameters consists only of (A) an address of said building and/or the apartment belonging to said building, (B) in case of an apartment, an area of said apartment, of (C) said building type of said building, and of (D) a number of levels of said building.
5. A computing system according to any of the previous points 3 to 4, characterized in that, said database comprises comparative apartment data representing relative pricing levels for reconstructing each of a plurality of different apartment types; in that said method comprises the step (d) determining apartment-type data for said apartment belonging to said building, the apartment-type data being selected from the plurality of different apartment types and the step (g) retrieving relevant comparative apartment data from the database based on the apartment type data determined in step (d); and in that said apartment-type data determined in step (d) is determined at least partly based on said number of levels.
6. A computing system according to any of the previous points 1 to 5, characterized in that, said further user input parameters comprise an indication relating to any or any combination of the following: a current commercial purpose for said building, a former commercial purpose for said building, a second home, a houseboat, a chalet, a caravan, a listed building, a thatched roof, said building being under construction, said building being designated for demolition, said building being in a state of disrepair, ground surface, the building being located in a flood plain, the presence of solar panels, the building being in a foreign country, the user possessing items of high value.
7. A computing system according to any of the previous points 1 to 6, characterized in that, step (h) further comprises generating a variance relating to said reconstruction-cost estimate to be generated in step (h), said variance characteristic of the accuracy of said reconstruction-cost estimate.
8. A computing system according to point 7, characterized in that, said variance obtained in step (h) is used to decide whether sufficient information is available for generating said reconstruction-cost estimate, and preferably to decide on which user input parameters to retrieve in step (h.2).
9. A computing system according to any of the previous points 1 to 8, characterized in that, step (c) comprises determining an estimate of the number of floors of said building based on a height and/or a ground surface and/or a number of rooms and/or a size of a largest room of said building as retrieved in step (b).
10. A computing system according to any of the previous points 1 to 9, characterized in that, step (h) comprises verifying whether a ground surface exceeds a threshold ground surface value.
11. A computing system according to any of the previous points 1 to 10, characterized in that, said database comprises one or more datasets of which at least one dataset is situated at a remote location with respect to said server.
12. A computing system according to any of the previous points 1 to 11, characterized in that, said database comprises neighborhood data about a neighborhood surrounding said address, said neighborhood data comprising any or any combination of the following: median income, urbanization type, socio-economic data about neighborhood such as income statistics or living situation, overall population density, population density by age.
13. A computing system according to any of the previous points 1 to 12, characterized in that, said computing system is further configured for carrying out a method for generating a prospect, said method comprising the steps of:
   (01) receiving user capacity input belonging to said user input and relating to a capacity of the user, said capacity concerning an owner-occupier and/or an owner-landlord and/or a tenant;
   (02) receiving prospect-related user input belonging to said user input, said prospect-related user input comprising the presence and surface of a swimming pool and/or the presence and surface of a garden and/or the presence of a fuel oil tank and/or the construction year of the building and/or the presence of a parking space;
   (03) generating a prospect comprising a premium based at least partly on said reconstruction-cost estimate and further comprising one or more optional insurances determined at least partly on said user input relating to said prospect-related feature received in step (02).
14. A computing system according to the previous point 13, characterized in that, said step (03) comprises determining whether said prospect can be accepted by said system, said determining taking into account a risk relating to said relating to said user input and/or further information available relating to said user.
15. A prospect produced by the system according to the previous point 14, said prospect comprising a visualization either on a screen of a user device of said user or on a print-out of data received on said user device of said user; said prospect comprising said premium and a list of said optional insurances, each of said optional insurances visualized with an associated premium surcharge determined by said system.

According to said further aspect and relating to said points 1-15, the present invention provides a computing system for estimation of a reconstruction cost, the computing system comprising
a server, the server comprising a processor, tangible non-volatile memory, program code present on said memory for instructing said processor;
at least one computer-readable medium, the at least one computer-readable medium comprising a database, said database comprising reconstruction-pricing data comprising:
   a plurality of price-index data indexed by a corresponding geographic location and representing reconstruction-pricing data for a plurality of different building types and a plurality of different building-area types within a building,
   comparative building-category data representing relative pricing levels for reconstructing each of a plurality of different building categories, and
   optionally, comparative apartment data representing relative pricing levels for reconstructing each of a plurality of different apartment types within a building;

said computing system configured for carrying out a method for said estimation of said reconstruction cost for a building and/or an apartment belonging to said building, said method comprising the steps of:
(b) receiving a set of key user input parameters belonging to a user input from a user at said server; said key user input relating to said building and/or said apartment belonging to said building from a user;
(c) retrieving building-related data relating to said user input from said database;
(d) determining building category-defining data for said building based on said building-related data;
(e) optionally, determining apartment-type data for said apartment belonging to said building, the apartment-type data being selected from the plurality of different apartment types;
(f) retrieving price-index data relating to said user input from said database;
(g) retrieving relevant comparative building-category data from the database for said building based on the building category-defining data determined in step (c);
(h) optionally, retrieving relevant comparative apartment data from the database based on the apartment type data determined in step (d);
(i) determining whether sufficient information is available for generating a reconstruction-cost estimate for the building and/or the apartment belonging to said building:
   (h.1) if yes, proceeding to step (i);
   (h.2) if no, receiving further user input parameters belonging to said user input from said user and returning to step (b);
(j) generating said reconstruction-cost estimate for the building and/or the apartment belonging to said building based at least on the price-index data retrieved in step (e), the relevant comparative building-category data retrieved in step (f) and optionally the relevant comparative apartment data in step (g);

whereby said set of key user input parameters consists only of (A) an address of said building and/or an apartment belonging to said building, (B) in case of an apartment, an area of said apartment, and optionally of (C) said building type of said building and/or optionally of (D) a number of levels of said building, and in that said building type of said building is one of a row house, a semi-detached house, a detached house or an apartment building.

An advantage of such a system is the user-friendliness offered to the user of the system. Rather than being required to go through an extensive list of questions before obtaining a prospect, as is the case with prior art systems, the user is simply required input on a very limited number of key user input parameters, of which the address is the main one, optionally complemented with the building type of the building and the number of levels of the building. In case that the estimation of said reconstruction cost is envisaged for an apartment belonging to said building, also the area of said apartment is requested. Hereby, this user input and particularly the address is used to retrieve data from a database. While it is possible that further user input parameters are requested at a second stage, there is a considerable chance that the user is helped without requiring receiving those further user input parameters, leading to a quick generation of a reconstruction-cost estimate and, in a preferred embodiment, of a prospect.

Furthermore, note that also the selection of key user input parameters in itself is advantageous. Indeed, in the current information society context, the address in itself provides access to a plethora of information regarding the building or apartment, including aerial images and 3D views such as Google Street View. The number of floors is particularly relevant to complement knowledge present in the database, for instance to verify the correctness of a height value present in the database. This may facilitate the derivation of an average surface per floor (in m²). In its turn, knowledge of the average surface per floor allows to use a unit cost per surface, preferably obtained in step (e), to derive a reconstruction cost estimate for a floor, an apartment or an entire building. This is advantageous because typically the number of floors can be obtained reliably from the user, whereas for the living area (in m²), the estimate given by the user is prone to errors. The type of building is relevant because may be indicative of the overall value of the property.

Also for the system administrator managing the system, the present invention provides benefits. Due to the very limited amount of user input required to arrive at a reconstruction-cost estimate, the user interface can be simplified. In a preferred embodiment, the database comprises one or more datasets of which at least one dataset is situated at a remote location with respect to said server. Such remote data set part may be operated by a third party. The remote data set may be freely accessible or may be accessible under specific conditions relating to service agreements. The advantage thereof is that external information may be accessed which is kept up to date by a third party, reducing the burden on the system administrator.

Another advantage concerns the improved accuracy of the estimate when compared to prior art systems. While prior art systems typically gather a lot of information by using an extensive list of questions for the user to answer, the relation between the answers and the cost estimate was typically based on some generalization and prone to errors. For instance, relying on the number of rooms to estimate the reconstruction cost is far from reliable due to the large differences between building styles and due to current trends in building. Indeed, over the past decennia, the number of rooms per house has overall declined while the surface of a room has on average increased. Therefore, using an extensive list of questions and then relying on historical correlations is far from accurate. In contrast, the present invention follows a data-driven approach, whereby particularly the address forms the key to the electronic and automated retrieval of a lot of information which was not available in electronic form until recently.

In a preferred embodiment of the present invention, the system according to the present invention is further configured for carrying out a method for generating a prospect, said method comprising the steps of:
(01) receiving user capacity input belonging to said user input and relating to a capacity of the user, said capacity concerning an owner-occupier and/or an owner-landlord and/or a tenant;
(02) receiving prospect-related user input belonging to said user input, said prospect-related user input comprising the presence and surface of a swimming pool and/or the presence and surface of a garden and/or the presence of a fuel oil tank and/or the construction year of the building and/or the presence of a parking space;
(03) generating a prospect comprising a premium based at least partly on said reconstruction-cost estimate and further comprising one or more optional insurances determined at least partly on said user input relating to said prospect-related feature received in step (02).

Herein, the term “prospect” refers to a commercial offering relating to the insurance of the building or the apartment belonging to said building, and based at least partly on the reconstruction cost or the estimate thereof. Furthermore, the term “capacity” encompasses any person/party responsible for said building or said apartment belonging to said building, regardless of the exact context relating this person/party to the people actually residing or spending time in it. This context may be captured in a conventional contract but may also be a hospitality service such as Airbnb.

The advantage thereof is that the user may receive a full prospect after entering only a limited number of key user input parameters. This is advantageous because it fits the demands of the user looking not only for a reconstruction-cost estimate but rather for an entire home prospect online, desiring a simple and fast process, with as little actions asked as possible. In a further preferred embodiment, said step (03) comprises determining whether said prospect can be accepted by said system, said determining taking into account a risk relating to said user input and/or further information available relating to said building or apartment and optionally relating to said user. From the point of view of an insurer associated with said prospect, this is advantageous since it results in an early filtering of requests of users, whereby only those prospects which cannot be automatically generated require personal attention of an employee of the insurer.

In a further aspect, preferably relating to said points 1-15, the present invention provides a prospect produced by the system according to the present invention, said prospect comprising a visualization either on a screen of a user device of said user or on a print-out of data received on said user device of said user; said prospect comprising said premium and a list of said optional insurances, each of said optional insurances visualized with an associated premium surcharge determined by said system.

In a further aspect relating to said points 1-15, the invention provides a system that according to any of claims 11-14 and, concurrently, any of points 1-14, with e.g. a system according to claim 1 and point 1, or a system according to claim 1 and point 2.

In a preferred embodiment, said set of key user input parameters consists only of (A) an address of said building and/or the apartment belonging to said building, (B) in case of an apartment, an area of said apartment, and of (C) said building type of said building. In a related preferred embodiment, said set of key user input parameters consists only of (A) an address of said building and/or the apartment belonging to said building, (B) in case of an apartment, an area of said apartment, and of (D) a number of levels of said building. Both embodiments have the advantage that only two key user input parameters are required from the user, leading to enhanced user experience. In another preferred embodiment, said set of key user input parameters consists only of (A) an address of said building and/or the apartment belonging to said building, of (B) in case of an apartment, an area of said apartment, of (C) said building type of said building, and of (D) a number of levels of said building. With only three key user input parameters required from the user, also this embodiment is advantageous in terms of user-friendliness.

In a preferred embodiment, said database comprises comparative apartment data representing relative pricing levels for reconstructing each of a plurality of different apartment types; whereby said method comprises the step (d) determining apartment-type data for said apartment belonging to said building, the apartment-type data being selected from the plurality of different apartment types and the step (g) retrieving relevant comparative apartment data from the database based on the apartment type data determined in step (d); whereby said apartment-type data determined in step (d) is determined at least partly based on said number of levels. The advantage of taking into account different apartment types is in itself advantageous since it allows better accuracy for the reconstruction-cost estimate. By basing the apartment-type data at least partly on the number of levels, the minimal information provided by the user is put to use maximally.

According to another preferred embodiment of the present invention, said further user input parameters comprise an indication relating to any or any combination of the following: a current commercial purpose for said building, a former commercial purpose for said building, a second home, a houseboat, a chalet, a caravan, a listed building, a thatched roof, said building being under construction, said building being designated for demolition, said building being in a state of disrepair, ground surface, the building being located in a flood plain, the presence of solar panels, the building being in a foreign country, the user possessing items of high value. Hereby, a reason to request for further user input parameters from the user is that the set of key user parameters is not sufficiently detailed to calculate an accurate reconstruction cost estimate. According to a preferred embodiment, another reason may be that there is insufficient information to decide whether said prospect should be accepted. Requesting the further user input parameters only later on instead of from the very beginning is beneficial since it allows in many cases to obtain a construction-cost estimate and/or a prospect without the user being required to enter further user input parameters.

According to a further preferred embodiment, step (h) further comprises generating a variance relating to said reconstruction-cost estimate to be generated in step (h), said variance characteristic of the accuracy of said reconstruction-cost estimate. As a statistical measure, this variance is indicative of the deviation that can be expected when comparing the obtained reconstruction-cost estimate to another reconstruction cost value, e.g. a reconstruction cost value obtained by manual intervention and detailed manual analysis, the “actual” reconstruction cost hereafter. The variance may also be associated with a certain interval situated around the estimate, whereby the interval is indicative of the range in which the “actual” reconstruction cost can likely be found. Hereby, in a preferred embodiment, the likelihood with which the “actual” reconstruction cost may be found in the described interval may be expressed in terms of a percentage, e.g. 95%, indicating that the “actual” reconstruction cost may be found with e.g. 95% in the given interval. In a preferred embodiment, the variance may advantageously be used to trigger certain decisions, whereby a certain threshold value may be used to decide whether a variance is e.g. “low enough” or “too high”. A first decision of this kind is whether or not the prospect associated with the reconstruction cost calculation can be accepted. This is also discussed below. Hereby, a high variance may be indicative of too large uncertainty, triggering the decision not to accept the prospect, and to advise the user to reside to a personal interview with the branch/agent. A low variance, on the other hand, may indicate a good quality of the estimate, indicating that the prospect may be generated, at least if all other conditions relating to this decision are fulfilled. A second decision of this kind is the decision in step (h) whether or not sufficient information is available. Hereby, if the variance is found too high, it may be advisable to request the user for further user input parameters, according to step (h.2). On the other hand, if the variance is found low enough, it may not be required to request further user input parameters from the user, according to step (h.1).

In another preferred embodiment, said variance obtained in step (h) is used to decide whether sufficient information is available for generating said reconstruction-cost estimate, and preferably to decide on which user input parameters to retrieve in step (h.2). As discussed above, the variance may be used advantageously to trigger certain decisions. In a further preferred embodiment, the variance obtained not only trigger whether further user input parameters should be received, but, in the case further user input parameters are required, to decide on the number and kind of user parameters required. For instance, a variance that is only slightly too high may require only a small number of additional questions to be presented to the user, whereas an excessively large variance may require a larger number of additional questions to be asked.

In a preferred embodiment, step (c) comprises determining an estimate of the number of floors of said building based on a height and/or a ground surface and/or a number of rooms and/or a size of a largest room of said building as retrieved in step (b). This is advantageous particularly in the case that the height and/or a ground surface and/or a number of rooms and/or a size of a largest room of said building are readily available parameters in the database, e.g. in an external dataset gathered by a third party and/or government. As mentioned above, when the height and the ground surface are available, this information can be combined with the number of floors to derive an average surface per floor. This, in its turn, can be used at least partly to derive a reconstruction cost estimate, by using a unit cost per surface, preferably obtained in step (e). The number of rooms and/or the size of the largest room can be further used to improve the accuracy of the calculation and/or to test/improve the quality of the estimate of the average surface per floor.

In a preferred embodiment, step (h) comprises verifying whether a ground surface exceeds a threshold ground surface value. This is advantageous since it allows to take into account the situation where a building has many annexes at ground floor level which do not extend to the floors above the ground floor. An excessively large ground surface value may be indicative thereof. In such case, the ground surface should not be taken along in the calculation since it leads to an inaccurate estimate of the average surface per floor. Thereby, it is advantageous to “clip” the ground surface value to a certain maximum value and use this maximum value instead of the original ground surface value in the further calculations.

In a preferred embodiment, the database comprises one or more datasets of which at least one dataset is situated at a remote location with respect to said server. Such remote data set part may be operated by a third party. The remote data set may be freely accessible or may be accessible under specific conditions relating to service agreements. The advantage thereof is that external information may be accessed which is kept up to date by a third party, reducing the burden of the system administrator(s) managing the system according to the present invention.

In yet another preferred embodiment, said database comprises neighborhood data about a neighborhood surrounding said address, said neighborhood data comprising any or any combination of the following: median income, urbanization type, socio-economic data about neighborhood such as income statistics or living situation, overall population density, population density by age. This is advantageous because it provides ample input to the statistical model underlying the cost calculation. From the experiments performed on available datasets, it is clear that not only the type of house but also data relating to the neighborhood may be indicative of reconstruction-cost-related features of the house, such as the types of materials used and the degree of finishing.

According to a preferred embodiment, said further user input parameters comprise an indication relating to any or any combination of the following: a current commercial purpose for said building, a former commercial purpose for said building, a second home, a houseboat, a chalet, a caravan, said building being listed, a thatched roof, said building being under construction, said building being designated for demolition, said building being in a state of disrepair, ground surface, the building being located in a flood plain, the presence of solar panels, the building being in a foreign country, the user possessing items of high value. The advantage hereof is that such further user input parameters may be used in step (i) to generate a more accurate reconstruction-cost estimate. Hereby, said building is listed if it is the object of restrictions relating to cultural heritage.

In a preferred embodiment, also further property-related information such as aerial images is taken into account when determining the reconstruction cost and/or when generating the prospect.

In another preferred embodiment, also further property-related information such as aerial images is taken into account when determining the risk.

In yet another embodiment, said set of key user input parameters consists only of (A) an address of said building and/or an apartment belonging to said building and optionally of (C) said building type of said building and/or optionally of (D) a number of levels of said building.

The invention is further described by the following non-limiting examples which further illustrate the invention, and are not intended to, nor should they be interpreted to, limit the scope of the invention.

### EXAMPLES

### Example 1: Example Flow Chart with Steps (1) to (9)

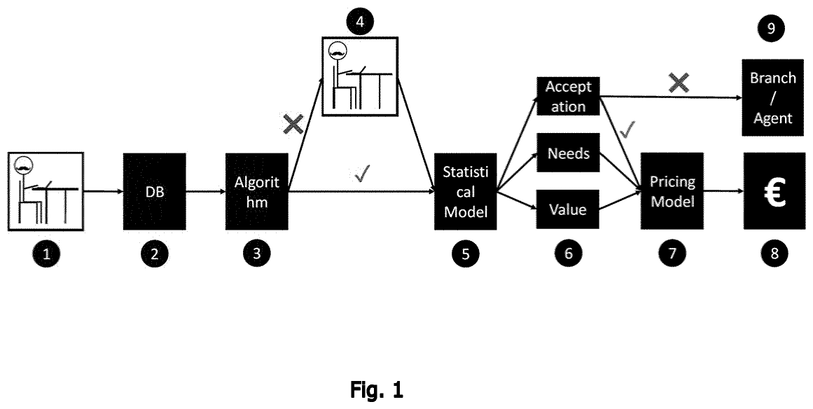

This example is illustrated by the flow chart of FIG. 1, with steps (1) to (9) as indicated. This example relates to the estimation of a reconstruction cost for a building or an apartment belonging to that building in the context of offering home insurance via a system presented to the user as an online platform. The building type may be an apartment building, a row house, a semi-detached house or a detached house, and the designated area may concern an apartment belonging to an apartment building or the entire building.

A key advantage of the system is that is enables an estimation of the reconstruction cost based on (very) limited user input. The user input concerns a (very) limited set of parameters given by a user. This fits the demands of the user looking for a home prospect online, desiring a simple and fast process, with as little actions asked as possible. For the cost estimation, the system follows a sequence of steps.

Step (1) concerns the user entering first user input, i.e. the key user input parameters, in this case the address of the property. The set of key user input parameters is received by a server which has the task to generate a home prospect, which entails determining the rebuilding-cost estimate.

In step (2), to generate the reconstruction-cost estimate, the server retrieves data from a database. The data comprises data about the property itself (type of the building, area, height) as well as data about the neighborhood (median income, urbanization type, socio-economic data about neighborhood such as income statistics or living situation, population). Preferably, the database comprises multiple datasets that are external to the insurance company handing out the prospects.

In step (3), based on the quality of the enriched data, the algorithm decides whether there is sufficient information for the model or not: if yes, the system jumps to step 5, otherwise the system moves to step (4).

In step (4), if needed, additional information is asked to the user. This is also referred to as further user input parameters.

In step (5), the system runs one or more statistical models on all information from the prospect together with information obtained from the database.

In step (6), acceptation, needs detection and value of a property are calculated as output of said one or more statistical models. Hereby, acceptation refers to the willingness of insurance company to accept said property and optionally said user for online insurance based on internal risk and/or product-specific criteria associated with the online process. Furthermore, needs determination refers on the one hand to determining the needs of a specific user for said property (e.g. whether he needs insurance for owner-occupier, owner-landlord, or tenant). On the other hand, needs detection comprises asking whether some additional insurances should be taken for said property, such as insurance for a swimming pool, insurance for a garden or insurance for a fuel oil tank. Value estimations refers to using a combination of prospect inputs (ultimately only the address for said property) and available internal and/or external data, processing said inputs and data through statistical model(s) and giving the correct estimation of rebuilding of said property. If there is no willingness to accept said prospect (implying acceptance of amongst other said user and said property), the system jumps to step (9). If there is willingness to accept said prospect, the system moves to step (7).

In step (7), the pricing model is applied to the statistical model output.

In step (8), the premium is calculated.

In step (9), the user is referred to the standard offline process with the branch/agent.

### Example 2: Example Embodiment with Flooding

In this example, said method according to claim 1 is applied in the case where the risk relates to flooding. Hereby, the risk relating to said probability of damage relates to a probability of damage caused by flooding of said physical entity. Said physical parameter and said at least one value of said physical parameter relate to a probability of flooding associated with a given physical location.

More preferably, the physical parameter relates to a flooding map of an area in which said physical entity is located, identifying zones with small and/or large likelihood of flooding, based on measurements over recent years. In one embodiment, for each location characterized e.g. by a set of geographical coordinates, the flooding map may indicate any or any combination of the following variables:
for a given time window, a Boolean value, indicating whether said location was flooded or not,
a numerical value p, 0<p<1, being the probability of potential flooding risk with respect to a given time period, e.g. the coming ten years,
an intensity of flooding over a given time window, taking into account the number of times the location flooded and/or the water level during a flooding event at the location.

The physical parameter may be any of these variables, or may be derived as a combination of these variables, e.g. as linear combination thereof, with weights which may be chosen based on experience and/or fitted to optimally fit some existing data set, according to some criterion such as least squared error.

In this example, the method of the present invention comprises the following example steps, which may be executed by a local server or a cloud computing service executed remotely.

A first step consists of receiving, from a user, a geographical address of said physical entity. The second step consists of receiving, from the user, an entity category relating to said physical entity, said entity category being one of a row house, a semi-detached house, a detached house or an apartment.

Then, a third step consists of automatically determining a set of geographical coordinates of said physical entity based on said geographical address. This is preferably done by consulting an “in-house” geographical database which is updated on a regular basis. Such an “in-house” database may for instance be stored at the server, or may be privately stored/accessible and maintained in the context of said cloud computing service. In an alternative step, said third step is performed by sending the geographical address to a third-party service, which, upon receipt of the geographical address, looks up and returns the set of geographical coordinates.

The fourth step consists of automatically retrieving at least one value of said physical parameter belonging to said physical data based on said geographical coordinates from a database. Particularly, for the given set of geographical coordinates, the flooding risk is retrieved from the database. This flooding risk is compared to a predefined value, wherein said at least one value of said physical parameter equaling or exceeding said predefined value selectively triggers an additional step in the method, i.e. the fifth, optional step.

The fifth step is optional and is selectively triggered by the fourth step. This step is only executed if high flooding risk is detected. The fifth step consists of receiving, from the user, an additional physical value being a risk-indicative feature value relating to said physical entity. Particularly, the risk-indicative feature value relates preferably to any of the following: a presence and/or physical surface of a subterranean space, preferably a basement, of said physical entity; a floor level of said physical entity in case said entity category is apartment. In one example, the physical entity is an apartment associated with high flooding risk, and the risk-indicative feature value is the floor level. Hereby, a floor level of 0 may indicate larger risk of damage due to flooding than e.g. a floor level equal to 1, 2, 3, 4, 5, 6 or 7. In another example, the physical entity is a semi-detached house and the risk-indicative feature value is the presence of a basement. Hereby, a basement being present may indicate an increased risk of damage due to flooding.

The sixth step consists of determining said risk based on at least on said entity category and said risk-indicative feature value.

In this example, these steps are performed via a dedicated graphical interface on a user device running a web service with a web-based application, i.e. a web service with a website. The physical entity may be of any entity category, and hence, the choice in the second step is explicitly made, by means of a dropdown menu or a list with a radio button. The application requests the user for the geographical address and the entity category for a plurality of purposes, of which the determining of risk is only one purpose. The application relates to the estimation of the reconstruction cost of said physical entity, for instance with a system and prospect according to points 1 to 15. The estimation comprises determining the risk, thereby assessing whether the physical entity is located in a flooding area, e.g. to determine the type of foundations required in reconstruction.

In an alternative example embodiment, the fifth step further and/or additionally comprises an advice with respect to the technical entity, said advice comprising a technical measure. The technical measure may e.g. relate to the lowering of the flooding risk, e.g. by eliminating a basement by filling it with filler material.

### Example 3: Example Embodiment with Other Physical Parameter

In this third example, the features are those of the second example, except that the physical parameter relates to another map. It may for instance relate to a fire risk map, which may relate to an area known for wildfire risk. In another example embodiment, the physical entity is located in an area with heightened seismic activity, such as natural seismic activity or seismic activity due to fracking or mining, and the physical parameter relates to a seismic map or an earthquake map. In this example, preferably a combination of physical parameters is considered, e.g. a combination of flooding risk, fire risk, and seismic risk.

1. A computer-implemented method for determining a risk associated with a physical entity based on physical data, said physical entity relating to real estate, said risk relating to a probability of damage of said physical entity with respect to a physical parameter comprised in said physical data, said method comprising the steps of:
receiving, from a user, a geographical address of said physical entity;
receiving, from the user, an entity category relating to said physical entity, said entity category being one of a row house, a semi-detached house, a detached house or an apartment;
automatically determining said risk based on at least on said entity category;
characterized in that said method further comprises the steps of
automatically determining a set of geographical coordinates of said physical entity based on said geographical address using a user device, the user device comprising a processor;
automatically retrieving at least one value of said physical parameter belonging to said physical data based on said geographical coordinates from a database using the user device;
in that said determining of said risk is further based on said at least one value of said physical parameter, and
in that said at least one value of said physical parameter is compared to a predefined value, wherein said at least one value of said physical parameter equaling or exceeding said predefined value selectively triggers an additional step in said method, wherein said additional step relates to receiving an additional physical value from said user and/or to providing additional information to said user.

2. The method according to claim 1, characterized in that said value of said physical parameter is based at least in part on automatic real-time measurement of said physical parameter.

3. The method according to claim 1 or 2, characterized in that said method comprises the further step of providing an output based on said risk to said user, said output comprising said risk and/or a risk category.

4. The method according to claim 1, characterized in that said additional step selectively triggered by said equaling or exceeding said predefined value relates at least to said receiving of said additional physical value, in that said additional step comprises:
receiving, from the user, said additional physical value being a risk-indicative feature value relating to said physical entity;
and in that said determining of said risk is further based on said risk-indicative feature value.

5. The method according to claim 4, characterized in that said method comprises the further step of:
providing, to the user, a first and second risk value, wherein said first risk value is determined without taking into account said risk-indicative feature value, and wherein said second risk value is determined taking into account said risk-indicative feature value, for quantifying an impact of said risk-indicative feature value on said risk and allowing said user to assess said impact.

6. The method according to claim 1, characterized in that said additional step selectively triggered by said equaling or exceeding said predefined value relates at least to said providing of said additional information to said user, in that said additional step comprises:
providing, to the user, additional information comprising an advice with respect to said physical entity, said advice comprising a technical measure;
and in that said technical measure relates to a modification of said physical entity which may be carried out by/via said user for lowering said risk.

7. The method according to claim 6, characterized in that said advice further comprises a first and second risk value, wherein said first risk value is determined assuming said technical measure is not implemented, and wherein said second risk value is determined assuming said technical measure is implemented, for quantifying an impact of said risk-indicative feature value on said risk and allowing said user to assess said impact.

8. The method according to claim 1, characterized in that said method comprises the further step of:
receiving, from the user, a characteristic value relating to said physical entity, said characteristic value relating to at least one of a physical surface or a number of floors characteristic of said physical entity;
and wherein said determining of said risk is further based on said characteristic value.

9. The method according to claim 1, characterized in that said method comprises the further step of:
providing, to the user, a construction or reconstruction requirement relating to said physical entity based on said risk, said entity category and on said characteristic value.

10. The method according to claim 1, characterized in that said method comprises the further steps of:
retrieving comparative entity-category data from a second database, said second database being said database, based on said entity category and further based on said characteristic value;
retrieving geo-indexed data from a third database, said third database being said database and/or said second database, based on said address and/or said entity category and/or said characteristic value; based on said address and said entity category and said characteristic value;
providing, to the user, a construction or reconstruction cost relating to said physical entity based at least on said risk, said comparative entity-category data, said geo-indexed data and further based on said characteristic value and/or said reconstruction requirement.

11. The method according to claim 1, characterized in that said risk relating to said probability of damage relates to a probability of damage caused by flooding of said physical entity; in that said physical parameter and said at least one value of said physical parameter relate to a probability of flooding associated with a given physical location.

12. The method according to claim 11, characterized in that
said additional step selectively triggered by said equaling or exceeding said predefined value relates at least to said receiving of said additional physical value; wherein said additional step comprises:
receiving, from the user, said additional physical value being a risk-indicative feature value relating to said physical entity;
wherein said determining of said risk is further based on said risk-indicative feature value; wherein said risk-indicative feature value relates to any of the following: a presence and/or physical surface of a subterranean space of said physical entity; a floor level of said physical entity in case said entity category is apartment;
and/or in that said additional step selectively triggered by said equaling or exceeding said predefined value relates at least to said providing of said additional information to said user, wherein said additional step comprises:
providing, to the user, additional information comprising an advice with respect to said physical entity, said advice comprising a technical measure;
wherein said technical measure relates to a modification of said physical entity which may be carried out by/via said user for lowering said risk, wherein said technical measure relates to a subterranean space of said physical entity and/or a lowest floor level of said physical entity.

13. A computing system for determining a risk associated with a physical entity based on physical data, said physical entity relating to real estate, said risk relating to a probability of damage of said physical entity with respect to a physical parameter comprised in said physical data, the computing system comprising
a server, the server comprising a processor, tangible non-volatile memory, program code present on said memory for instructing said processor;
a user device, the user device comprising a processor, tangible non-volatile memory, program code present on said memory for instructing said processor, a screen for displaying information to said user, input means for receiving a user input means from a user, connection means for connecting to said server;
at least one computer-readable medium, the at least one computer-readable medium comprising a database, said database comprising said physical data, said physical data comprising:
a plurality of values of said physical parameter indexed by corresponding geographical coordinates;
said computing system configured for determining a risk associated with a physical entity based on physical data, said method comprising the steps of:
receiving, by said server, a geographical address of said physical entity from said user via said input means;
receiving, by said server, an entity category relating to said physical entity, said entity category being one of a row house, a semi-detached house, a detached house or an apartment from said user via said input means;
automatically determining, by said server, said risk based on at least on said entity category;
characterized in that said method further comprises the steps of
automatically determining by said server a set of geographical coordinates of said physical entity based on said geographical address;
automatically retrieving by said server at least one value of said physical parameter belonging to said physical data based on said geographical coordinates from said database;
in that said determining of said risk is further based on said at least one value of said physical parameter, and
in that said at least one value of said physical parameter is compared to a predefined value, wherein said at least one value of said physical parameter equaling or exceeding said predefined value selectively triggers an additional step in said method, wherein said additional step relates to receiving an additional physical value from said user and/or to providing additional information to said user;
in that said value of said physical parameter is based at least in part on automatic real-time measurement of said physical parameter;
in that said method comprises the further step of providing an output based on said risk to said user, said output comprising said risk and/or a risk category;
in that
said additional step selectively triggered by said equaling or exceeding said predefined value relates at least to said receiving of said additional physical value,
in that, said additional step comprises:
receiving, from the user, said additional physical value being a risk-indicative feature value relating to said physical entity;
and in that said determining of said risk is further based on said risk-indicative feature value;
in that said method comprises the further step of:
providing, to the user, a first and second risk value, wherein said first risk value is determined without taking into account said risk-indicative feature value, and wherein said second risk value is determined taking into account said risk-indicative feature value, for quantifying an impact of said risk-indicative feature value on said risk and allowing said user to assess said impact;
in that
said additional step selectively triggered by said equaling or exceeding said predefined value relates at least to said providing of said additional information to said user,
in that said additional step comprises:
providing, to the user, additional information comprising an advice with respect to said physical entity, said advice comprising a technical measure;
and in that said technical measure relates to a modification of said physical entity which may be carried out by/via said user for lowering said risk;
in that said advice further comprises a first and second risk value, wherein said first risk value is determined assuming said technical measure is not implemented, and wherein said second risk value is determined assuming said technical measure is implemented, for quantifying an impact of said risk-indicative feature value on said risk and allowing said user to assess said impact;
in that
said method further comprises the step of:
receiving, from the user, a characteristic value relating to said physical entity, said characteristic value relating to at least one of a physical surface or a number of floors characteristic of said physical entity;
and wherein preferably said determining of said risk is further based on said characteristic value;
in that
said risk relating to said probability of damage relates to a probability of damage caused by flooding of said physical entity;
in that said physical parameter and said at least one value of said physical parameter relate to a probability of flooding associated with a given physical location;
and in that said risk-indicative feature value relates to any of the following: a presence and/or physical surface of a subterranean space of said physical entity; a floor level of said physical entity in case said entity category is apartment;
in that
said risk is determined in the context of a reconstruction advice with respect to said physical entity, in that said method comprises the further step of:
providing, to the user, said reconstruction advice with respect to said physical entity, said reconstruction advice comprising a technical requirement;
and in that said technical requirement relates to a reconstruction instruction with respect to said building, wherein the reconstruction instruction is an instruction with respect to a foundation and/or a fire protection provision and/or a dam and/or a detection system of seismic activity.

14. The system according to claim 13, characterized in that said determining of said set of geographical coordinates based on said geographical address is performed by a positioning-related remote server different from said server and/or in that said computer-readable medium comprising said database is comprised in a physical-parameter-related remote server different from said server.

15. The system according to claim 14, characterized in that said positioning-related remote server is equal to said physical-parameter-related remote server.

16. (canceled)

17. The method according to claim 1, wherein said triggering is done selectively in order to decrease both the necessary mental and physical effort of the user in determining said risk.

18. The system according to claim 13, wherein said triggering is done selectively in order to decrease both the necessary mental and physical effort of the user in determining said risk.
